(19) United States
(12) Patent Application Publication
(10) Pub. No.: US 2024/0060720 A1
(43) Pub. Date: Feb. 22, 2024

(54) BIN FOR FOOD DRYER

(71) Applicant: INTERCRATE CONTAINER CORP., West Vancouver (CA)

(72) Inventor: Justin Elvin-Jensen, West Vancouver (CA)

(21) Appl. No.: 18/451,651

(22) Filed: Aug. 17, 2023

Related U.S. Application Data
(60) Provisional application No. 63/398,643, filed on Aug. 17, 2022.

(51) Int. Cl. F26B 25/06; F26B 5/08

(52) U.S. Cl. CPC F26B 25/066; F26B 5/08

(57) ABSTRACT

In a removable bin for a dryer, the bin includes a floor and one or more walls extending from the floor. The one or more walls include a lower wall portion, a middle wall portion, and an upper wall portion. The lower wall portion is attached to the floor. The middle wall portion extends from the lower wall portion and includes a plurality of columns. Each of the columns includes a plurality of elongated slot openings extending through the one or more walls. The slot openings in adjacent ones of the columns are arranged in a staggered arrangement. The upper wall portion extends from the middle wall portion and includes a plurality of handholds.

### CROSS-REFERENCE TO RELATED APPLICATIONS

This application claims the benefit of U.S. Provisional Patent Application No. 63/398,643 filed 17 Aug. 2022, the contents of which are hereby incorporated by reference.

### TECHNICAL FIELD

The present disclosure relates to bins, and in particular, to removable bins for use with centrifugal spin dryers.

### BACKGROUND

Centrifugal spin dryers are commonly used in the agricultural industry to dry vegetables such as lettuce and cabbage. One such dryer is the SD50 Spin Dryer made by Heinzen Manufacturing International. The SD50 Spin Dryer accepts a removable bin loaded with produce (e.g. lettuce, cabbage, etc.) and spins the produce at high speeds (by rotating the bin) in order to remove excess water from the produce. The dryer comprises a cavity to accommodate the removable bin, with the bin typically positioned at an angle away from vertical when inserted into the dryer and with the open end of the bin generally facing upwards. A number of openings are also formed through the walls of the bin to allow for water to leave the bin.

When the dryer initially rotates the bin (e.g. at around 50 rpm), the produce itself is generally forced through centrifugal force to the perimeter of the bin. As the dryer increases its rotational speed (e.g. to up to 200 rpm), water on the produce may be forced outward and downward (through centrifugal force and gravity) from the produce. This water escapes from the bin through the openings. When the dryer stops, the resulting produce is dryer and can be unloaded for further processing or transport.

The bins currently used are typically made from conventional garbage or other all-purpose bins that have had multiple holes manually drilled through their walls. This is a tedious process requiring significant manpower and time. In addition, the holes are often drilled in a haphazard manner. For example, if too few holes are drilled, this could result in bins that suffer inconsistent or reduced effectiveness in draining the excess water. On the other hand, if too many holes are drilled, then the structural integrity of the bin may be compromised.

One example of a prior art bin is disclosed in U.S. Pat. No. 10,299,504 to Elvin-Jensen. The bin disclosed in Elvin-Jensen comprises a plurality of openings organized in a specific pattern along a height of the bin.

There is therefore a need for a removable bin that is both structurally sound and yet exhibits good water draining capabilities.

### SUMMARY

The present disclosure includes a removable bin for a dryer, with the bin comprising a floor and one or more walls extending from the floor. The one or more walls comprise a lower wall portion, a middle wall portion, and an upper wall portion. The lower wall portion is attached to the floor. The middle wall portion extends from the lower wall portion and comprises a plurality of columns. Each of the columns comprises a plurality of elongated slot openings extending through the one or more walls. The slot openings in adjacent ones of the columns are arranged in a staggered arrangement. The upper wall portion extends from the middle wall portion and comprises a plurality of handholds.

In one aspect, the floor is substantially circular, and the one or more walls comprise one wall.

In another aspect, the upper wall portion comprises an outwardly extending lip, with the lip defining, at least in part, an upper opening for the bin.

In still another aspect, the plurality of handholds comprises four handholds, and the four handholds are arranged approximately 90° apart.

In still yet another aspect, each of the handholds comprises a grip portion, two lateral supports, a lower handhold wall, and a handhold opening. The grip portion forms a portion of the lip. The two lateral supports extend from the grip portion. The lower handhold wall extends between at least a portion of the two lateral supports, with the lower handhold wall comprising a handhold edge extending between the two lateral supports. The handhold opening is defined, at least in part, by the handhold edge, the grip portion, and the two lateral supports.

In a further aspect, the lip comprises a first lip member, and the grip portion comprises a portion of the first lip member.

In still a further aspect, the grip portion further comprises a second lip member spaced apart from the first lip member.

In still yet a further aspect, the grip portion further comprises one or more lip ribs extending between the first lip member and the second lip member.

In another aspect, each of the lateral supports comprises two lateral walls spaced apart from each other.

In still another aspect, each of the lateral supports further comprises one or more connecting walls extending between the two lateral walls.

In still yet another embodiment, the handhold edge is curved.

In a further embodiment, the wall comprises inner and outer surfaces extending across at least the middle wall portion. The inner surface comprises a repeating pattern of surfaces, with each of the patterns extending for at least a portion of a height of the inner surface and comprising an elongated middle section, an elongated first end section, and an elongated second end section. The slot openings are located along the middle section. The first end section extends from one end of the middle section. The second end section extends from another end of the middle section. The first and second end sections are angled with respect to the middle section.

In still a further aspect, an angle between the middle section and the first end section is between approximately 170° and 179°. In yet still a further aspect, the angle between the middle section and the first end section is between approximately 176° and 177°.

In still a further aspect, an angle between the middle section and the second end section is between approximately 170° and 179°. In yet still a further aspect, the angle between the middle section and the second end section is between approximately 176° and 177°.

In another aspect, the bin is configured to nest within a second one of the bin in a nested configuration. In the nested configuration, the lateral supports of the bin are adapted to rest on the lip of the second one of the bin.

In a further aspect, a bin for a dryer comprises a substantially circular floor and a wall extending from the floor. The wall comprises first and second ends, with the floor connected to the wall proximate to the second end. The wall further comprises a plurality of columns, with each of the columns comprising a plurality of elongated slot openings extending through the one or more walls. The slot openings in adjacent ones of the columns are arranged in a staggered arrangement. The wall further comprises a plurality of handholds proximate to the first end.

In still a further aspect, the wall comprises an inner surface, with the inner surface comprising a repeating pattern of surfaces. Each of the patterns extends for at least a portion of a height of the inner surface and comprises an elongated middle section, an elongated first end section, and an elongated second end section. The slot openings are located along the middle section. The first end section extends from one end of the middle section, and the second end section extends from another end of the middle section. The first and second end sections are angled with respect to the middle section.

In still yet a further aspect, the plurality of handholds comprises four handholds, with the four handholds are arranged approximately 90° apart.

The foregoing was intended as a summary only and of only some of the aspects. It was not intended to define the limits or requirements of the disclosure. Other aspects will be appreciated by reference to the detailed description of the preferred embodiments. Moreover, this summary should be read as though the claims were incorporated herein for completeness.

### BRIEF DESCRIPTION OF THE DRAWINGS

The preferred embodiments will be described by reference to the drawings thereof, in which:

FIG. 1 shows an embodiment of the bin with a food dryer;

FIG. 2 shows a front view of the bin;

FIG. 3 shows a top perspective view of the bin;

FIG. 4 shows a bottom perspective view of the bin;

FIG. 5 is a partial view of the bin;

FIG. 6 shows the bin as carried by a user;

FIG. 7 is a partial view showing the interior surface of the bin;

FIG. 8 is another partial view showing the interior surface of the bin, as viewed from below;

FIG. 9 is yet another partial view showing the interior surface of the bin, as viewed from above;

FIG. 10 is a perspective view of two of the bins nested together;

FIG. 11 is a front partial view of two of the bins nested together; and

FIG. 12 is a partial sectional view of two of the bins nested together.

### DETAILED DESCRIPTION

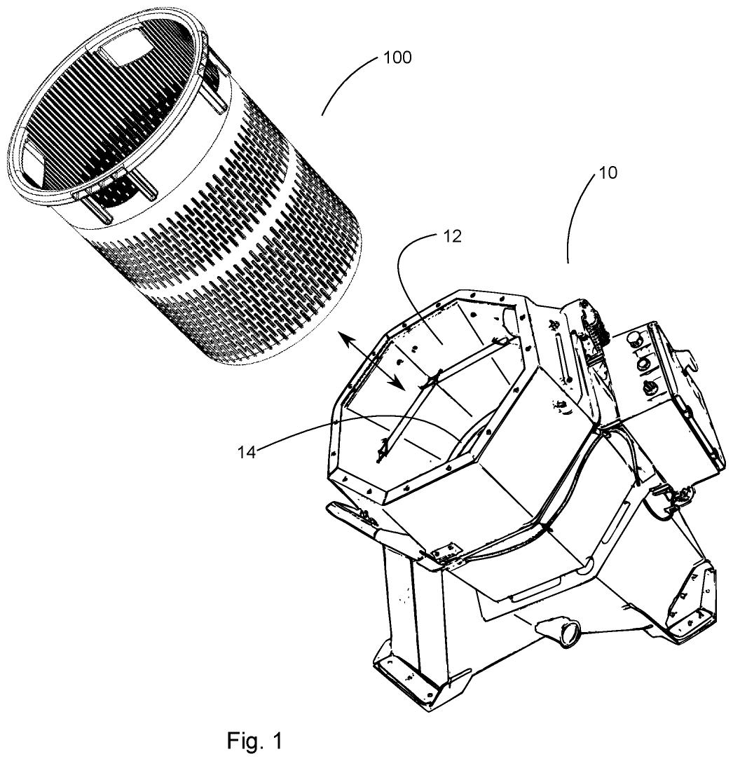

Referring to FIG. 1, a food dryer 10 (such as the SD50 Spin Dryer model manufactured by Heinzen Manufacturing Limited) comprises a cavity 12 that is adapted to accommodate a removable bin 100 in accordance with one embodiment. The bin 100 may be loaded with various contents, including produce 16 (e.g. lettuce, cabbage, etc.). After the bin 100 is loaded into the cavity 12, the food dryer 10 is configured to rotate the bin 100 at high speeds to remove excess water from the produce 16.

The cavity 12 is defined, at least in part, by a basket 14 located within the food dryer 10. The basket 14 may be constructed from metal and has a basket rim, one or more basket walls, and a basket floor (not shown). When the bin 100 is loaded into the cavity 12, the basket 14 generally comes into contact with and is located within the removable bin 100. A plurality of basket openings (not shown) may be formed on the basket walls and the basket floor.

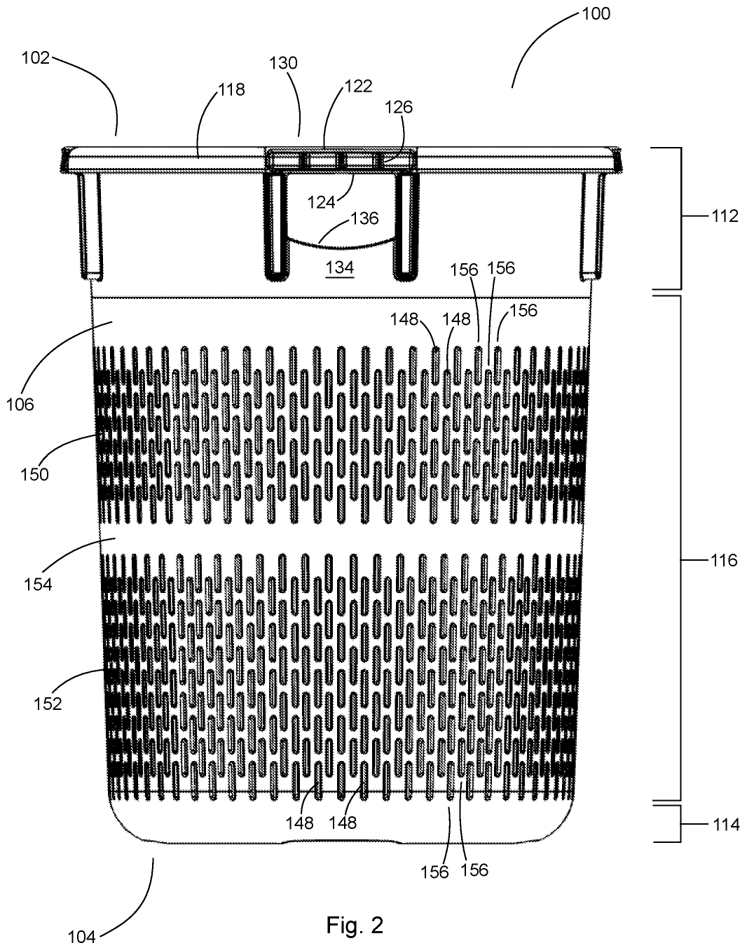

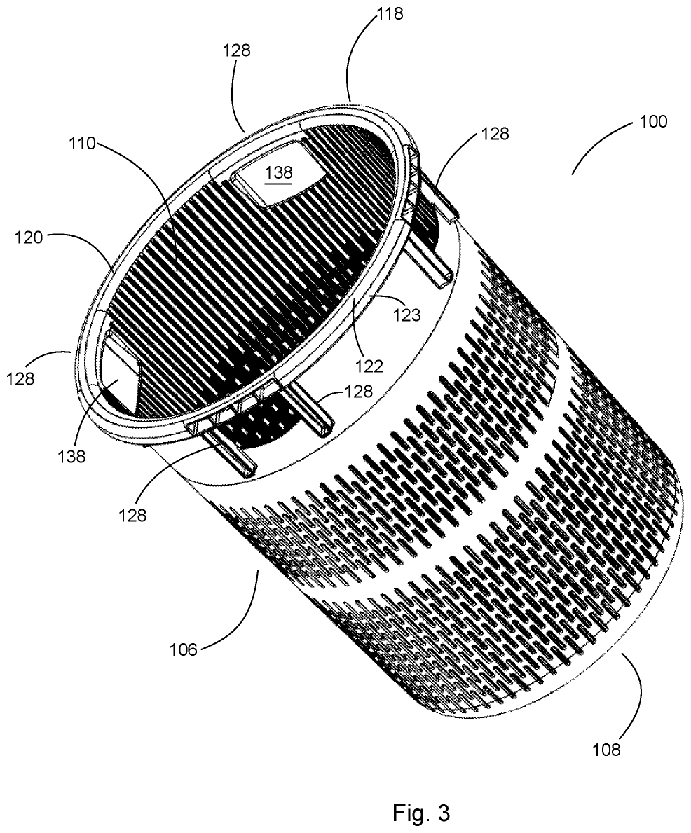

Referring to FIGS. 2 to 4, the bin 100 comprises first and second ends 102, 104, with the first end 102 being substantially open. The bin 100 further comprises one or more walls 106 extending between the first and second ends 102, 104 and a floor 108 attached to the wall 106 proximate to the second end 102. In some embodiments, the bin 100 may have a generally circular cross-section, in which case a single curved one of the walls 106 extends between the first and second ends 102, 104, as shown in FIG. 2. In some embodiments, the height of the bin 100 is approximately 28 inches, with the diameter of the bin (proximate to the first end 102) being approximately 20 inches.

The bin 100 comprises an interior 110 that is defined, at least in part, by the wall 106 and the floor 108, with the floor 108 providing a lower surface for the bin 100. The floor 108 may also provide a surface for engagement with the basket 14. The contents of the bin 100 may be loaded into and unloaded from the interior 108 through the first end 102.

Referring to FIG. 2, the wall 106 comprises an upper wall portion 112 proximate to the first end 102 and a lower wall portion 114 proximate to the floor 108. The wall 106 further comprises a middle wall portion 116 extending between the upper wall portion 112 and the lower wall portion 114. As best shown in FIG. 2, at least a portion of the wall 106 may be tapered, such that a diameter of the bin 100 proximate to the first end 102 is greater than a diameter of the bin 100 proximate to the second end 104. In some embodiments, a diameter of the bin 100 decreases gradually for at least a portion of the wall 106, moving in direction from the first end 102 to the second end 104. For example, in some embodiments, at least the middle wall portion 116 may be tapered. In other embodiments, both the upper wall portion 112 and the middle wall portion 116 may be tapered. The degree of taper may be between approximately 3° and approximately 4°.

Referring to FIGS. 2 to 5, the upper wall portion 112 comprises a lip 118 proximate to the first end 102. The lip 118 extends substantially along the first end 102 and defines, at least in part, an upper opening 120 into the interior 110. The lip 118 may comprise a first lip member 122 extending outwardly proximate to the first end 102. The lip 118 may further comprise a lateral lip member 123 extending from the first lip member 122. One or more interior ribs 125 may extend among the first lip member 122, the lateral lip member 123, and a portion of the wall 106 to provide additional strength and rigidity to the lip 118 and to the upper wall portion 112 generally.

122, 124 that may be spaced apart from each other. One or more lip ribs 126 may extend between portions of the first and second lip members 122, 124 to provide additional strength and rigidity to the lip 118 and to the upper wall portion 112 generally.

The upper wall portion 112 further comprises one or more handholds 128. In the embodiment shown in FIGS. 2 to 5, the upper wall portion 112 comprises four of the handholds 128, with the handholds 128 arranged approximately 90° apart; however, it is understood that other numbers of handholds 128 and other arrangements/orientations of the handholds 128 are also possible. Having four of the handholds 128 arranged approximately 90° apart may allow for a more even distribution of the weight of the bin 100. In addition, having four of the handholds 128 (compared to two, for example) means that it will be more likely that one of the handholds 128 will be at a location convenient to a user 18 when the bin 100 is to be grabbed (e.g. for removal from the cavity 12).

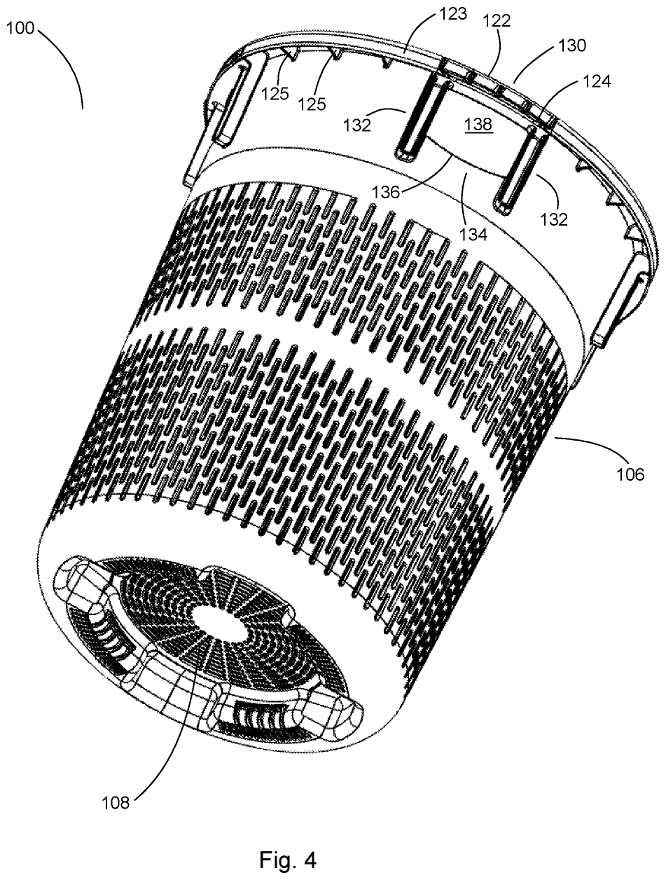

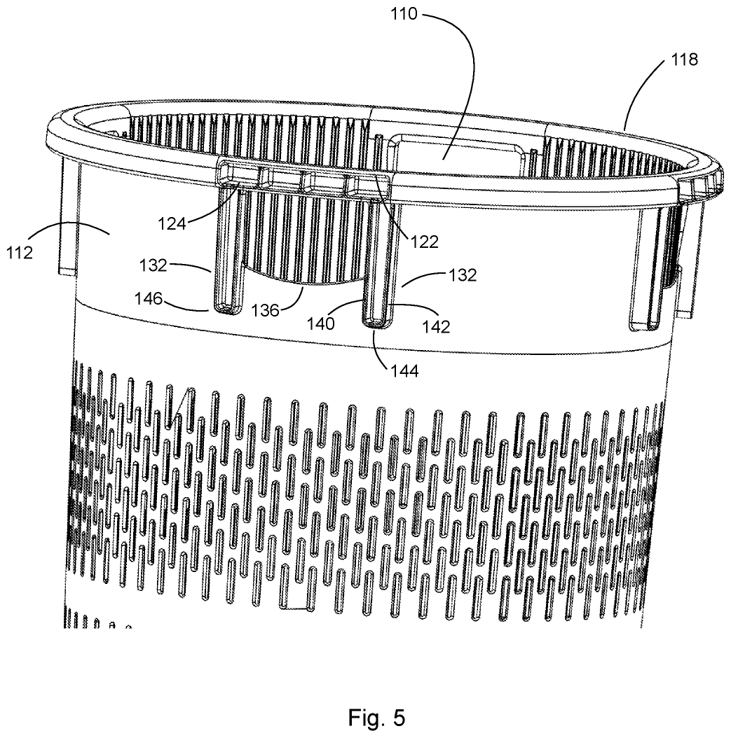

Referring to FIGS. 4 and 5, each of the handholds 128 comprises a grip portion 130. The grip portion 130 is adapted to be gripped by the user 18 when handling the bin 100, and at least a portion of the grip portion 130 may be part of the lip 118. The grip portion 130 comprises a portion of the first lip member 122. The grip portion 130 further comprises a second lip member 124 that is substantially parallel to and spaced apart from the first lip member 122. In some embodiments, one or more lip ribs 126 extend between the first lip member 122 and the second lip member 124 within the grip portion 130. The lip ribs 126 may provide strength and rigidity to the grip portions 130, as the grip portions 130 may encounter additional stress when handled by the user 18.

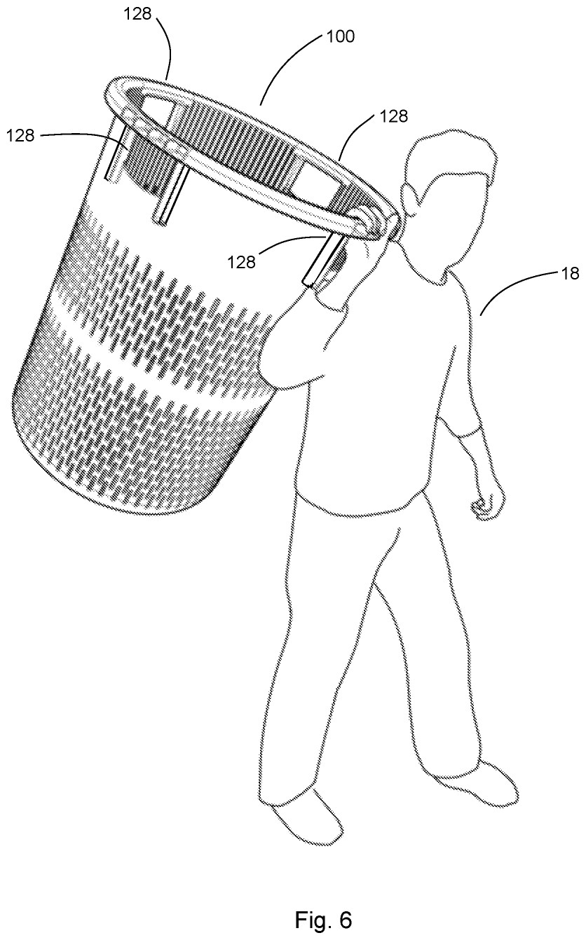

In some embodiments, the handhold 128 further comprises a pair of lateral supports 132 extending generally downwardly from the grip portion 130. The handhold 128 further comprises a lower handhold wall 134 extending between portions of the lateral supports 132. The lower handhold wall 134 comprises a handhold edge 136 extending between the lateral supports 132. Referring to FIG. 4, the handhold 128 comprises a handhold opening 138 that is defined, at least in part, by the handhold edge 136 and portions of the lateral supports 132 and the grip portion 130. The handhold opening 138 is adapted to allow for a hand of the user 18 to pass through (as shown in FIG. 6). For example, the user 18 may grasp the bin 100 by passing his or her hand through one of the handhold openings 138 and gripping the grip portion 130. The handhold opening 138 may be sized sufficiently large to allow the hand to pass through but not so large as to allow excess produce 16 to escape therethrough from the interior 110.

Each of the lateral supports 132 may comprise inner and outer lateral walls 140, 142 that are spaced apart from each other. One or more connecting walls 144 may extend between the inner and outer lateral walls 140, 142. Referring to FIG. 5, the lateral supports 132 comprise a lower support end 146 that extends within the upper wall portion 112. In some embodiments, one of the connecting walls 144 extend between the inner and outer lateral walls 140, 142 proximate to the lower support end 146. The lateral supports 132 provide additional strength and rigidity to the lip 118 and to the handhold 128.

Referring to FIG. 2, the middle wall portion 116 comprises a plurality of slot openings 148 extending through the middle wall portion 116 and that are adapted for drainage of water and to permit water to escape from the bin 100 when the food dryer 10 is in operation. In some embodiments, as exemplified by the embodiment shown in FIG. 2, the slot openings 148 are located in first and second regions 150, 152 of the middle wall portion 116. A band 154 separates the first and second regions 150, 152, with the slot openings 148 not present within the band 154. The location of the band 154 may correspond to the location of the basket rim when the bin 100 is placed within the cavity 12 and the basket 14. In some embodiments, the second region 152 may have a greater height than that of the first region 150.

In some embodiments, the band 154 may be omitted, such that the slot openings 148 are not interrupted by the band 154.

The slot openings 148 are arranged in a plurality of columns 156, with each of the columns 156 containing a plurality of the slot openings 148 arranged in a substantially end-to-end arrangement, except within the band 154, if the band 154 is present. In some embodiments, the slot openings 148 in adjacent ones of the columns 156 are staggered such (as shown in FIG. 2), such that the slot openings 148 in adjacent ones of the columns 156 are not aligned. The slot openings 148 are elongated, with a width of between approximately 1/16 inch and approximately ¼ inch. In some embodiments, the slot openings 148 have a width of approximately ⅛ inch. The slot openings 148 have a height of between approximately 1 to approximately 1½ inches. The dimensions of the slot openings 148 are such that the contents of the bin 100 (e.g. the produce 16) may not likely be able to escape from the bin 100 during the drying process. In addition, the dimensions of the slot openings 148 are such that water from within the bin 100 may not generally escape from the bin 100 when the bin 100 is stationary; however, when the bin 100 is rotated by the food dryer 10, the centrifugal force created by the rotation may tend to drive water through the slot openings 148.

The arrangement of the slot openings 148 (and in particular, the staggering of the slot openings 148 in adjacent ones of the columns 156) may result in water only have to travel a short distance between encountering one of the slot openings 148. This may facilitate the movement of water out of the bin 100. When the bin 100 is rotated by the food dryer 10, the water within the bin 100 may also tend to move upwards (i.e. from the second end 104 towards the first end 102) or downwards (i.e. from the first end 102 towards the second end 104). Because of the staggering of the slot openings 148 in adjacent ones of the columns 156, regardless of the direction of water movement, the water may likely encounter one of the slot openings 148 (and thereby may have the opportunity to leave the bin 100).

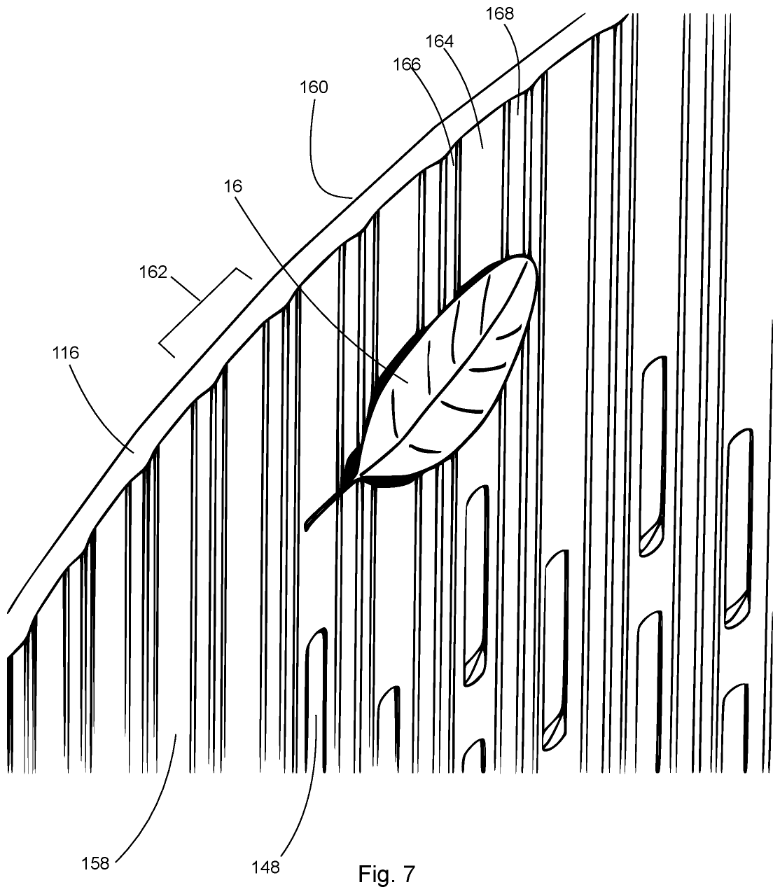

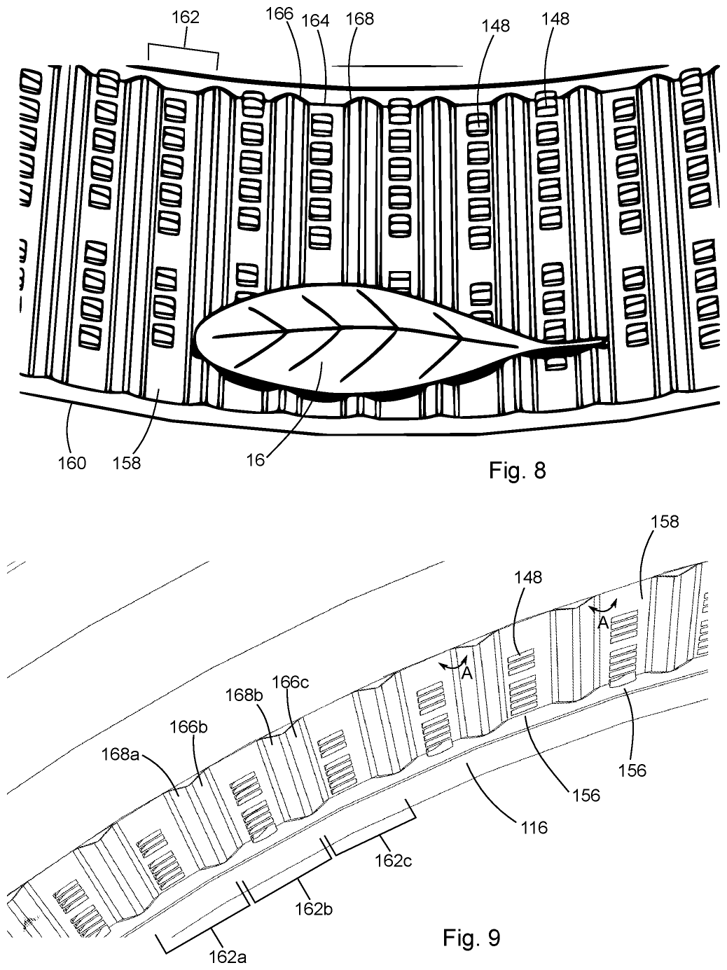

Referring to FIGS. 7 to 9, the wall 106 may comprise inner and outer surfaces 158, 160. The inner and outer surfaces 158, 160 may extend across at least the middle wall portion 116. However, in some embodiments, the inner and outer surfaces 158, 160 may extend into the upper and/or lower wall portions 112, 114. For example, in one embodiment, the inner and outer surfaces 158, 160 may extend across substantially an entirety of the upper wall portion 112.

At least a portion of the inner surface 158 may have a substantially faceted texture. In particular, the inner surface 158 may comprise a repeating pattern 162 of surfaces, with the pattern 162 comprising an elongated, substantially planar middle section 164 extending between elongated first end section 166 and elongated second end section 168. The middle section 164 and the first and second end sections 166, 168 extend for at least a portion of a height of the inner surface 158. In some embodiments, the middle section 164 and the first and second end sections 166, 168 may extend for substantially an entire height of the inner surface 158.

The first and second end sections 166, 168 may be angled with respect to the middle section 164. In one embodiment, an angle A formed by the middle section 164 and either of the first and second end sections 166, 168 is between approximately 170° and 179° (as shown in FIG. 9). In another embodiment, the angle A is between approximately 176° and 177°. The outer surface 160 may be substantially smooth, except for the presence of the slot openings 148.

In some embodiments, the slot openings 148 are located along the middle sections 164.

As shown in FIGS. 7 to 9, the first end section 166 of one of the patterns 162 is connected to the second end section 168 of an adjacent one of the patterns 162. Similarly, the second end section 166 of the one of the patterns 162 is connected to the first end section of another adjacent one of the patterns 162. For example, the patterns 162a, 162b, 162c (as shown in FIG. 9) may form part of the middle wall portion 116. The first end section 166b of the pattern 162b is connected to the second end section 168a of the pattern 162a. The second end section 168b of the pattern 162b is connected to the first end section 166c of the pattern 162c.

The repeating of the patterns 160 along at least a portion of the interior surface 158 may produce an effect that is akin to the “lotus effect”, which discourages surface adhesion from occurring. This may reduce the likelihood of the produce 16 (e.g. leaves thereof) in the bin 100 from sticking to the inner surface 144.

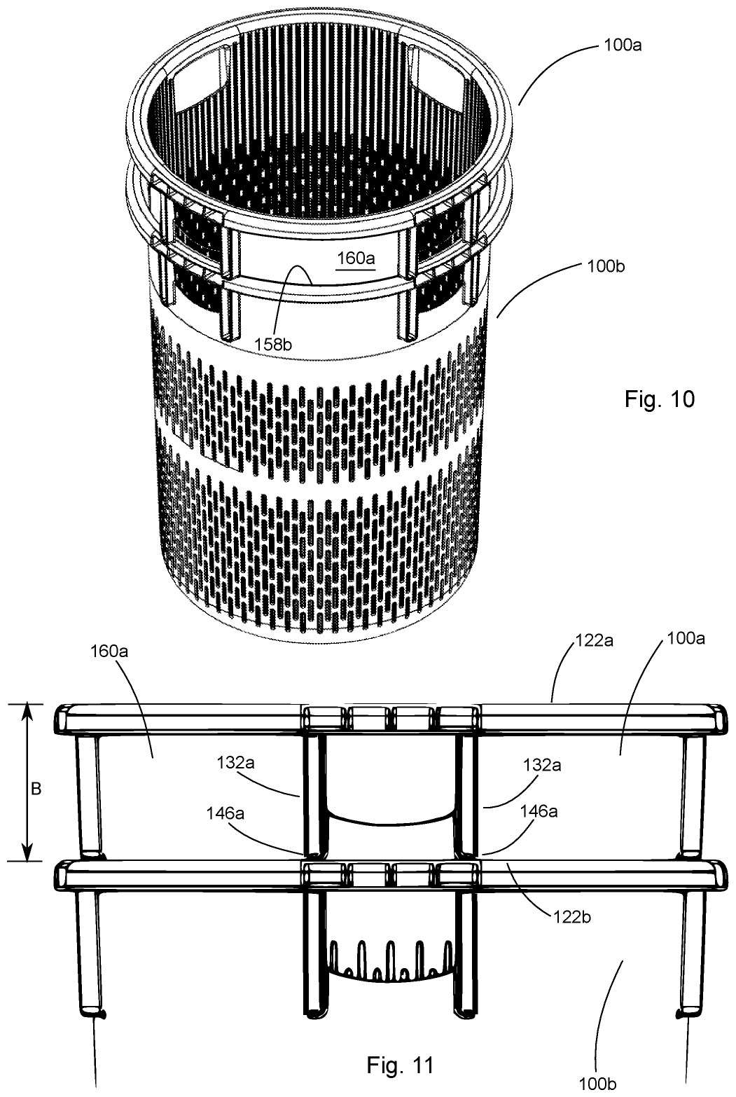

Referring to FIGS. 10 to 12, in some embodiments, one of the bins 100 may be nested within another one of the bins 100. For example, in FIGS. 10 and 11, a first one of the bins 100 (i.e. the bin 100a) may be nested within a second one of the bins 100 (i.e. the bin 100b). When the bin 100a is lowered within the bin 100b to nest the bin 100a within the bin 100b, the lower support end 146a of the lateral supports 132a of the bin 100a will eventually abut against the first lip member 122b of the bin 100b, thereby preventing any further downward movement of the bin 100a with respect to the bin 100b.

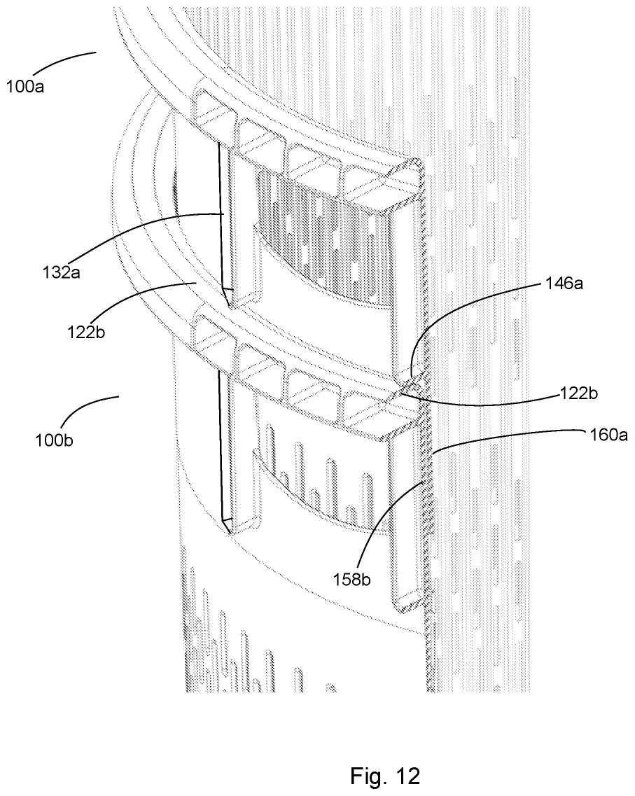

In some embodiments, referring to FIG. 12, the abutment of the lower support end 146a against the first lip member 122b prevents the bin 100a from nesting fully within the bin 100b. In other words, the outer surface 160a of the bin 100a does not fully engage against the inner surface 158b of the bin 100b. This separation between the outer surface 160a and the inner surface 158b of the bins 100a, 100b, respectively allows for objects (e.g. the leaves of the produce 16) in between the bins 100a, 100b to be move downward, without be stuck between the outer surface 160a and the inner surface 158b.

As the lateral supports 132 may extend beyond a height of the handhold opening 138, when the bin 100a is nested within the bin 100b, the handhold opening 138a is fully exposed and is not covered, even partially, by the bin 100b. In some embodiments, referring to FIG. 11, a nesting increment B (defined as a height between the first lip member 122a and the first lip member 122b of the bins 100a, 100b, respectively) is between approximately 80 mm and approximately 100 mm. In some embodiments, the nesting increment B is approximately 90 mm. The amount of the nesting increment B is determined, at least in part, by a height of the lateral supports 132.

At least a portion of the bin 100 may be molded, such as from injection-molded plastic.

It will be appreciated by those skilled in the art that the preferred embodiments have been described in some detail but that certain modifications may be practiced without departing from the scope of this disclosure.

1. A removable bin for a dryer, the bin comprising:
a floor; and
one or more walls extending from the floor, the one or more walls comprising:
a lower wall portion attached to the floor;
a middle wall portion extending from the lower wall portion, the middle wall portion comprising:
a plurality of columns, each of the columns comprising a plurality of elongated slot openings extending through the one or more walls, wherein the slot openings in adjacent ones of the columns are arranged in a staggered arrangement; and
an upper wall portion extending from the middle wall portion, the upper wall portion comprising a plurality of handholds.

2. The bin of claim 1, wherein the floor is substantially circular, and wherein the one or more walls comprise one wall.

3. The bin of claim 2, wherein the upper wall portion comprises an outwardly extending lip, wherein the lip defines, at least in part, an upper opening for the bin.

4. The bin of claim 3, wherein the plurality of handholds comprises four handholds, and wherein the four handholds are arranged approximately 90° apart.

5. The bin of claim 4, wherein each of the handholds comprises:
a grip portion, the grip portion forming a portion of the lip;
two lateral supports extending from the grip portion;
a lower handhold wall extending between at least a portion of the two lateral supports, the lower handhold wall comprising a handhold edge extending between the two lateral supports; and
a handhold opening defined, at least in part, by the handhold edge, the grip portion, and the two lateral supports.

6. The bin of claim 5, wherein the lip comprises a first lip member, and wherein the grip portion comprises a portion of the first lip member.

7. The bin of claim 6, wherein the grip portion further comprises a second lip member spaced apart from the first lip member.

8. The bin of claim 7, wherein the grip portion further comprises one or more lip ribs extending between the first lip member and the second lip member.

9. The bin of claim 5, wherein each of the lateral supports comprises two lateral walls spaced apart from each other.

10. The bin of claim 9, wherein each of the lateral supports further comprises one or more connecting walls extending between the two lateral walls.

11. The bin of claim 5, wherein the handhold edge is curved.

12. The bin of claim 2, wherein the wall comprises inner and outer surfaces extending across at least the middle wall portion, the inner surface comprising a repeating pattern of surfaces, each of the patterns extending for at least a portion of a height of the inner surface and comprising:
an elongated middle section, wherein the slot openings are located along the middle section;
an elongated first end section extending from one end of the middle section; and
an elongated second end section extending from another end of the middle section;
wherein the first and second end sections are angled with respect to the middle section.

13. The bin of claim 12, wherein an angle between the middle section and the first end section is between approximately 170° and 179°.

14. The bin of claim 13, wherein the angle between the middle section and the first end section is between approximately 176° and 177°.

15. The bin of claim 12, wherein an angle between the middle section and the second end section is between approximately 170° and 179°.

16. The bin of claim 13, wherein the angle between the middle section and the second end section is between approximately 176° and 177°.

17. The bin of claim 5, wherein the bin is configured to nest within a second one of the bin in a nested configuration, and wherein in the nested configuration, the lateral supports of the bin are adapted to rest on the lip of the second one of the bin.

18. A bin for a dryer, the bin comprising:
a substantially circular floor; and
a wall extending from the floor, the wall comprising:
first and second ends, wherein the floor is connected to the wall proximate to the second end;
a plurality of columns, each of the columns comprising a plurality of elongated slot openings extending through the one or more walls, wherein the slot openings in adjacent ones of the columns are arranged in a staggered arrangement; and
a plurality of handholds proximate to the first end.

19. The bin of claim 18, wherein the wall comprises an inner surface, the inner surface comprising a repeating pattern of surfaces, each of the patterns extending for at least a portion of a height of the inner surface and comprising:
an elongated middle section, wherein the slot openings are located along the middle section;
an elongated first end section extending from one end of the middle section; and
an elongated second end section extending from another end of the middle section;
wherein the first and second end sections are angled with respect to the middle section.

20. The bin of claim 18, wherein the plurality of handholds comprises four handholds, and wherein the four handholds are arranged approximately 90° apart.
